(19) United States
(12) Patent Application Publication
(10) Pub. No.: US 2016/0141634 A1
(43) Pub. Date: May 19, 2016

(54) SEPARATOR FOR FUEL CELL

(71) Applicant: TOYOTA JIDOSHA KABUSHIKI KAISHA, Toyota-shi (JP)

(72) Inventors: Tsuyoshi SEGUCHI, Toyota-shi (JP); Yusuke WATANABE, Toyota-shi (JP)

(73) Assignee: TOYOTA JIDOSHA KABUSHIKI KAISHA, Toyota-shi (JP)

(21) Appl. No.: 14/938,476

(22) Filed: Nov. 11, 2015

(30) Foreign Application Priority Data
Nov. 14, 2014 (JP) 2014-231692

(51) Int. Cl. H01M 8/02; H01M 8/04

(52) U.S. Cl. CPC H01M 8/0228; H01M 8/04544; H01M 8/0213; H01M 8/04671; H01M 2008/1095

(57) ABSTRACT

Disclosed is a separator for a fuel cell which is able to suppress peeling off or cracking of a conductive carbon film occurring at the time of insertion and extraction of a cell monitor terminal.

The separator for a fuel cell includes a terminal attachment portion which is disposed in a region other than a power generation region engaged in power generation of a separator, and to which a cell monitor terminal capable of detecting the voltage of the single cell is connected, and a conductive carbon thin film layer which is formed on the terminal attachment portion, and the hardness of the carbon thin film layer is greater than or equal to 5 GPa and less than or equal to 10 GPa.

### BACKGROUND OF THE INVENTION

1. Field of the Invention

The present invention relates to a separator for a fuel cell.

2. Background Art

For example, a proton exchange membrane fuel cell has a structure in which a plurality of single cells exhibiting a power generation function is stacked.

Each of the single cells includes a membrane electrode assembly (MEA) including a pair of (an anode and a cathode) catalytic layers (referred to as an “electrode catalytic layer”) interposing a polymer electrolyte film therebetween, and a pair of (an anode and a cathode) gas diffusion layers (GDL) for interposing the catalytic layers therebetween and for dispersing supply gas. Then, the MEA included in each of the single cells is electrically connected to the MEA of the adjacent single cell through a separator. Thus, the single cells are stacked and connected, and thus a fuel cell stack is configured. Then, this fuel cell stack is able to function as power generation means which is able to be used in various usages.

In the fuel cell stack described above, the separator, as described above, exhibits a function of electrically connecting the adjacent single cells, and in general, a gas passage is disposed on the surface of the separator facing the MEA. The gas passage functions as gas supply means for respectively supplying fuel gas and oxidizing gas to the anode and the cathode.

However, in the separator of each of the single cells configuring the fuel cell stack as described above, a terminal of a cell monitor (a cell monitor terminal) is attached to a terminal attachment portion on a circumferential edge. This cell monitor terminal has an extremely important role of monitoring a power generation state of the fuel cell in operation, of performing output control, and of notifying that maintenance is required by monitoring of an abnormal fuel cell.

In this terminal attachment portion, it is necessary that the cell monitor terminal conducts well over a long period of time using generated electricity, and thus excellent conductivity and high durability are required. Therefore, for example, in Patent Document 1 described below, a technology is proposed in which a carbon layer (a conductive carbon film) formed of graphitized carbon is formed on the terminal attachment portion of the separator.

### CITATION LIST

### Patent Document

[Patent Document 1] JP2012-099386 A

### SUMMARY OF THE INVENTION

In the separator disclosed in Patent Document 1 described above, the conductive carbon film is formed in the terminal attachment portion of the separator, and thus excellent conductivity is ensured, but the repetitive insertion and extraction properties of the terminal attachment portion of the separator and the durability in a contact point portion with respect to the cell monitor terminal are not considered. For this reason, peeling off or cracking occurs in the conductive carbon film at the time of the insertion and extraction of the cell monitor terminal. Thus, in the separator of the related art, there are problems to be solved.

The present invention is made in consideration of such problems, and an object thereof is to provide a separator for a fuel cell which is able to suppress peeling off or cracking of a conductive carbon film occurring at the time of insertion and extraction of a cell monitor terminal.

In order to solve the problems described above, a separator for a fuel cell according to an aspect of the present invention used in a single cell which is a power generation element of a fuel cell includes a terminal contact mounting surface which is disposed in a region other than a power generation region engaged in power generation of a separator main body, and to which a cell monitor terminal capable of detecting a voltage of the single cell is connected; and a conductive carbon thin film layer which is formed on the terminal contact mounting surface, in which hardness of the carbon thin film layer is greater than or equal to 5 GPa and less than or equal to 10 GPa.

In the separator for a fuel cell according to the aspect of the present invention, the hardness of the conductive carbon thin film layer formed on a terminal contact mounting surface to which the cell monitor terminal is connected is set to be greater than or equal to 5 GPa and less than or equal to 10 GPa. By setting the hardness of the carbon thin film layer to be greater than or equal to 5 GPa, the hardness of the carbon thin film layer is sufficiently ensured. As a result thereof, it is possible to withstand impact such as contact or friction from the outside, and thus for example, it is possible to suppress the peeling off of the carbon thin film layer even at the time of the insertion and extraction of the cell monitor terminal (at the time of detachment of the cell monitor terminal). In addition, when the hardness of the carbon thin film layer is excessively high, a crack easily occurs in the carbon thin film layer at the time of the insertion and extraction of the cell monitor terminal, but it is possible to suppress the cracking of the carbon thin film layer even at the time of the insertion and extraction of the cell monitor terminal by setting the hardness of the carbon thin film layer to be less than or equal to 10 GPa.

In addition, in the separator for a fuel cell according to the aspect of the present invention, it is preferable that a frictional coefficient of the carbon thin film layer is less than or equal to 0.15.

According to the present invention, it is possible to provide a separator for a fuel cell which is able to suppress peeling off or cracking of a conductive carbon film occurring at the time of insertion and extraction of a cell monitor terminal.

### BRIEF DESCRIPTION OF THE DRAWINGS

FIG. 1 is an explanatory diagram illustrating a schematic configuration of a fuel cell stack including a single cell to which a separator according to an embodiment of the present invention is applied,

FIG. 2 is a plan view illustrating a schematic configuration of the separator according to the embodiment of the present invention.

FIG. 3 is an enlarged diagram of a circle W illustrated in FIG. 2.

FIGS. 4A and 4B are diagrams for illustrating a state in which a cell monitor terminal is connected to the separator illustrated in FIG. 2.

FIG. 5 is a diagram in which a conventional example is compared with an example with respect to a relationship between the number of times of sliding and sliding resistance.

FIG. 6 is a diagram in which the conventional example is compared with the example with respect to a relationship between hardness of a carbon thin film layer and the sliding resistance.

FIG. 7 is a diagram in which the conventional example is compared with the example with respect to a frictional coefficient.

FIG. 8 is a diagram in which the conventional example is compared with the example with respect to a Young's modulus.

### DESCRIPTION OF THE PREFERRED EMBODIMENTS

An embodiment of the present invention will be described with reference to the following accompanying drawings. The present invention will be described with reference to the following preferred embodiment, but the present invention is able to be changed by various methods without deviating from the range of the present invention, and embodiments other than this embodiment are able to be used. Accordingly, all changes within the range of the present invention are included in claims.

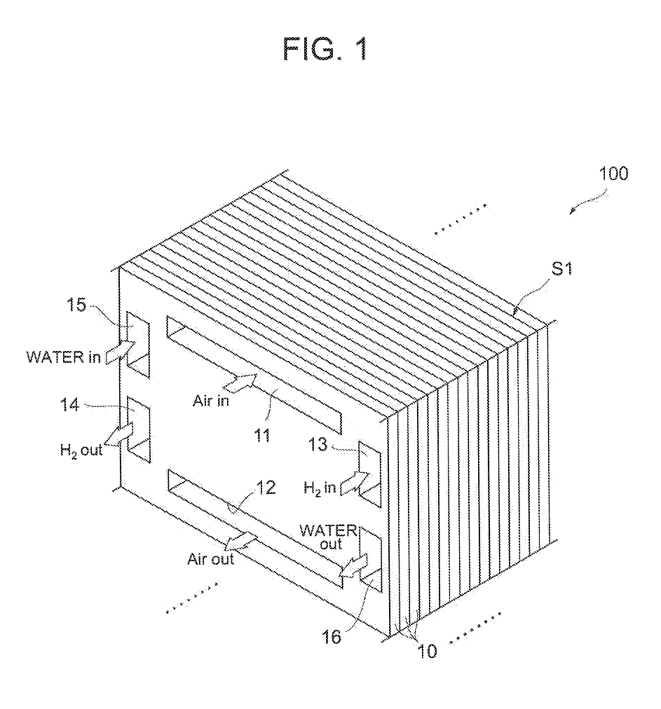

FIG. 1 is an explanatory diagram illustrating a schematic configuration of a fuel cell stack including a fuel cell (a single cell) to which a separator according to an embodiment of the present invention is applied.

A fuel cell stack 100 has a stack structure in which a plurality of single cells 10 which is a power generation element is stacked. The fuel cell stack 100 includes the plurality of stacked single cells 10, an oxidizing gas supply manifold 11, an oxidizing gas discharge manifold 12, a fuel gas supply manifold 13, a fuel gas discharge manifold 14, a cooling medium supply manifold 15, and a cooling medium discharge manifold 16, and in the example of FIG. 1, a stacked portion of the single cells 10 in the fuel cell stack 100 is illustrated, and other portions are omitted.

Each of the single cells 10 includes six through holes formed along a thickness direction, and in a state where the single cells 10 are stacked, six manifolds 11 to 16 described above are formed in the fuel cell stack 100 through these six through holes. Furthermore, the number and the shape of through holes and manifolds are not limited to the example illustrated in FIG. 1, and the number of these through holes and manifolds is able to be suitably changed.

The oxidizing gas supply manifold 11 supplies air as oxidizing gas which is supplied from an air compressor (not illustrated) to each of the single cells 10. The oxidizing gas discharge manifold 12 discharges surplus air (cathode side off-gas) which has not been used in each of the single cells 10. The fuel gas supply manifold 13 supplies hydrogen gas as fuel gas which is supplied from a hydrogen gas tank (not illustrated) to each of the single cells 10. The fuel gas discharge manifold 14 discharges surplus hydrogen gas (anode side off-gas) which has not been used in each of the single cells 10. The cooling medium supply manifold 15 supplies a cooling medium to each of the single cells 10. The cooling medium discharge manifold 16 discharges the cooling medium which has been used in each of the single cells 10.

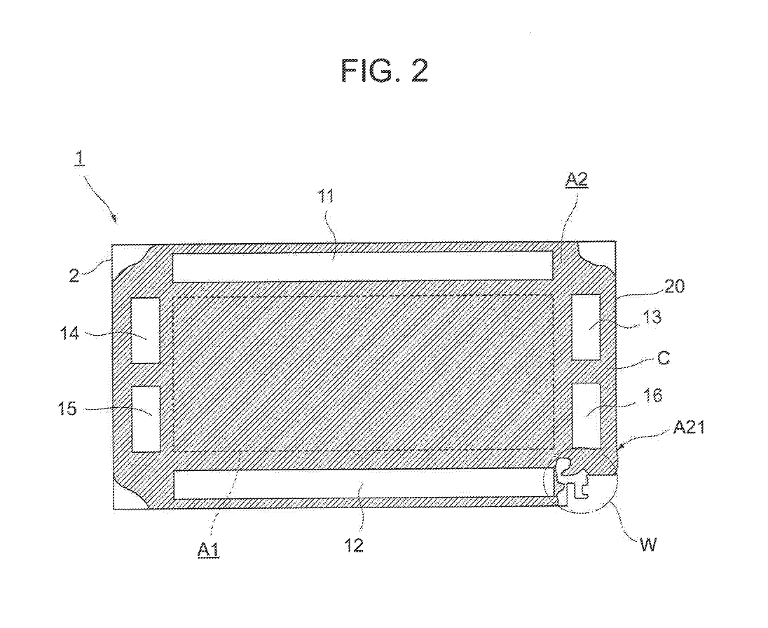

Subsequently, the separator according to the embodiment of the present invention will be described. FIG. 2 is a plan view illustrating a schematic configuration of the separator which is applied to the single cell illustrated in FIG. 1.

Furthermore, the single cell 10 described above at least includes a membrane electrode assembly (not illustrated), a pair of separators 1 (refer to FIG. 2) interposing the membrane electrode assembly therebetween, and the like. The membrane electrode assembly is configured of an electrolyte film, and a pair of electrodes interposing the electrolyte film from both surfaces, the hydrogen gas as the fuel gas is supplied to one electrode (an anode), and an oxidizing gas such as air is supplied to the other electrode (a cathode). An electrochemical reaction occurs in the membrane electrode assembly due to this hydrogen gas and oxidizing gas, and thus an electromotive force of the single cell 10 is obtained.

The separator 1 (a separator main body) will be described. As illustrated in FIG. 2, the separator 1 has a rectangular outer shape. As the material of the separator 1, for example, a thin plate (a separator base material 2) of a metal such as stainless steel (SUS) or titanium is used. In the separator 1, the manifolds 11 to 16 described above are formed through the thickness direction.

The separator 1 will be further described. The center portion of the separator 1 is a power generation region A1 (a region in a dotted frame of FIG. 2) corresponding to a power generation unit of the single cell 10, the circumference of the power generation region A1 is a non-power generation region A2 (a region outside of the dotted frame A1 of FIG. 2), and openings for the manifolds 11 to 16 described above are disposed in the non-power generation region A2. Specifically, “11” is an opening for forming the oxidizing gas supply manifold, “12” is an opening for forming the oxidizing gas discharge manifold, “13” is an opening for forming the fuel gas supply manifold, “14” is an opening for forming the fuel gas discharge manifold, “15” is an opening for forming the cooling medium supply manifold, and “16” is an opening for forming the cooling medium discharge manifold. Furthermore, the number and the shape of openings for a manifold formed in the separator 1 are not limited to the example illustrated in FIG. 2, and are able to be suitably changed. In addition, the region A1 illustrated in FIG. 2 corresponds to the power generation region engaged in power generation of the separator main body of the present invention.

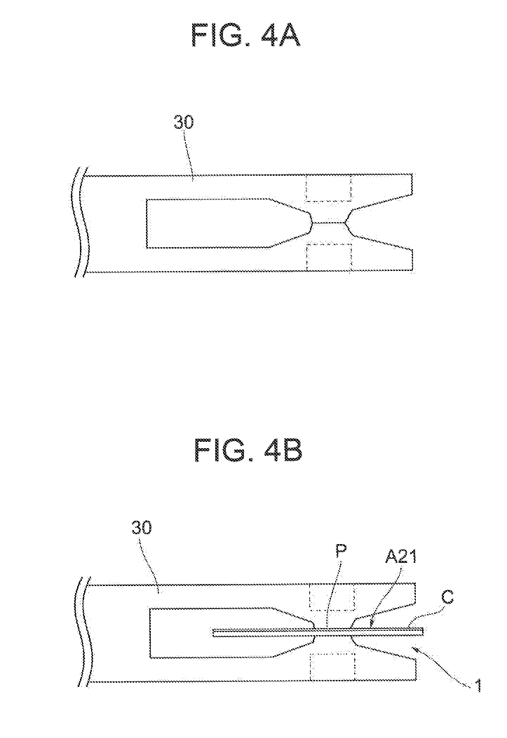

As illustrated in FIG. 2, a carbon thin film layer C having excellent conductivity is formed in the power generation region Al and the non-power generation region A2 described above. As a forming method of this carbon thin m layer C, for example, a surface treatment (amorphous carbon) using a CVD method is included. By performing such a surface treatment, the hardness of the carbon thin film layer C is improved to greater than that of titanium used in the separator base material 2, and a frictional coefficient is reduced, and thus the insertability of a cell monitor terminal 30 (refer to FIGS. 4A and 4B) is improved.

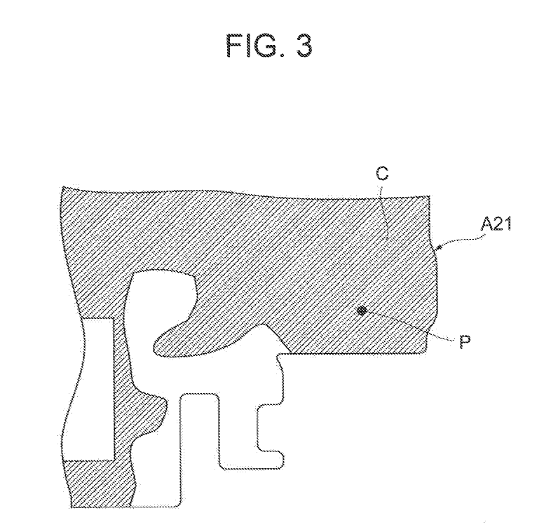

A terminal attachment portion A21 disposed in a part of the non-power generation region A2 described above and the cell monitor terminal 30 connected to the terminal attachment portion A21 described above will be described. FIG. 3 is a schematic plan view of the terminal attachment portion A21. FIGS. 4A and 4B are diagrams for illustrating the connection of the cell monitor terminal 30. More specifically, FIG. 4A is a diagram illustrating a state where the cell monitor terminal 30 is not yet connected to the terminal attachment portion A21 of the separator 1, and FIG. 4B is a diagram illustrating a state where the cell monitor terminal 30 is connected to the terminal attachment portion A21 of the separator 1. The cell monitor terminal 30 is subjected to a surface treatment using Ni plating.

The terminal attachment portion A21 illustrated in FIG. 3 is a region to which the cell monitor terminal 30 is connected, and as described above, the carbon thin film layer C is formed in the terminal attachment portion A21 described above. A clip-shaped cell monitor terminal 30 as illustrated in FIGS. 4A and 4B is attached to a contact point P of the terminal attachment portion A21 of the separator 1. As it is obvious in FIGS. 4A and 4B, when the cell monitor terminal 30 is detached, the surface of the cell monitor terminal 30 and the surface of the separator 1 slide over each other in the terminal attachment portion A21, and thus the cell monitor terminal 30 is detached.

A function of the cell monitor terminal 30 illustrated in FIGS. 4A and 4B will be described below. The cell monitor terminal 30 has a function capable of detecting a voltage of each single cell 10 or a plurality of the cells, and a function of monitoring a power generation state of the single cell 10 (the fuel cell) in operation, of performing output control, and of notifying that the maintenance is required by monitoring of an abnormal single cell 10. For this reason, it is necessary that the electricity generated in the single cell 10 is excellently conducted to the cell monitor terminal 30, and as described above, the carbon thin film layer C having excellent conductivity is formed in the terminal attachment portion A21.

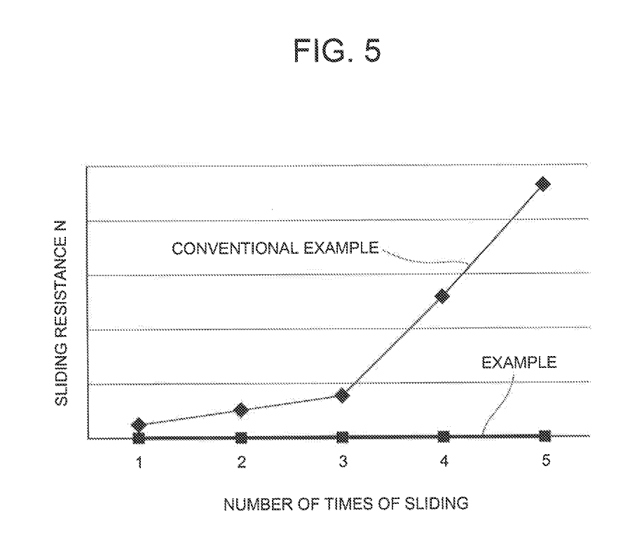

Next, results of performing a test with respect to the separator coated with the carbon thin film layer will be described. The present inventors have performed a sliding test with respect to each of a case where the cell monitor terminal 30 is attached to the separator 1 (an example) coated with the carbon thin film layer C having hardness of greater than or equal to 5 GPa and less than or equal to 10 GPa and a case where the cell monitor terminal 30 is attached to the separator 1 (a conventional example) coated with a carbon thin film layer having the other hardness. As the result of this sliding test, the results illustrated in FIG. 5 to 8 have been obtained.

First, a result in which a relationship between the number of times of sliding and sliding resistance is verified will be described. FIG. 5 is a graph in which the example is compared with the conventional example with respect to the number of times of sliding and the sliding resistance at the time of sliding the cell monitor terminal over the separator (at the time of insertion and extraction of the cell monitor terminal). Furthermore, the number of times of sliding corresponds to the number of times of detaching the cell monitor terminal 30 (the number of times of insertion and extraction of the cell monitor terminal 30), and the sliding resistance corresponds to resistance acting on the cell monitor terminal 30 at the time of sliding the cell monitor terminal 30 over the separator 1.

As illustrated in FIG. 5, in the conventional example, the cell monitor terminal attachment portion of the separator is not subjected to a surface treatment of conductive carbon, and thus it is confirmed that the sliding resistance increases as the number of times of sliding increases. The Ni plating used in the surface treatment of the cell monitor terminal is attached to the surface of the separator by sliding the cell monitor terminal, and thus the sliding resistance increases. In contrast, in the example, it is confirmed that the sliding resistance does not increase even when the number of times of sliding of the cell monitor terminal 30 increases. Thus, in the example, the terminal attachment portion A21 is not subjected to the surface treatment, and thus the Ni plating used in the surface treatment of the cell monitor terminal 30 is not attached to the surface of the separator 1, and the sliding resistance is able to be suppressed.

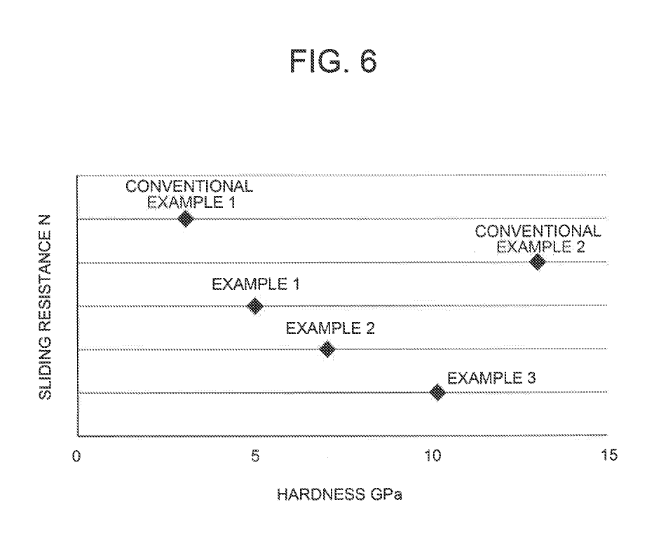

Subsequently, a result in which a relationship between the hardness of the carbon thin film layer coated on the separator and the sliding resistance is verified will be described. FIG. 6 is a graph in which the example is compared with the conventional example with respect to the relationship between the hardness of the carbon thin film layer and the sliding resistance.

When the data of Conventional Examples 1 and 2 is compared with the data of Examples 1 to 3 illustrated in FIG. 6, it is confirmed that the sliding resistance of the carbon thin film layer having the hardness of the example (greater than or equal to 5 GPa and less than or equal to 10 GPa) is smaller than the sliding resistance of a case where the carbon thin film layer having the hardness of the conventional example (in Conventional Example 1, the hardness of the carbon thin film layer is greater than or equal to 0 GPa and less than 5 GPa, and in Conventional Example 2, the hardness of the carbon thin film layer is greater than 10 GPa) is used, and the sliding resistance is able to be reduced in the example to lower than that in the conventional example.

As it is obvious in the same drawing, when the size of the sliding resistance is considered, it is preferable that the hardness of the carbon thin film layer C formed in the terminal attachment portion A21 of the separator 1 is set to be greater than or equal to 5 GPa and less than or equal to 10 GPa. Furthermore, it is confirmed that at the hardness of Conventional Example 1 (the hardness of the carbon thin film layer is greater than or equal to 0 GPa and less than 5 GPa), peeling off occurs in the carbon thin film layer, and at the hardness of Conventional Example 2 (the hardness of the carbon thin film layer is greater than 10 GPa), cracking occurs in the carbon thin film layer.

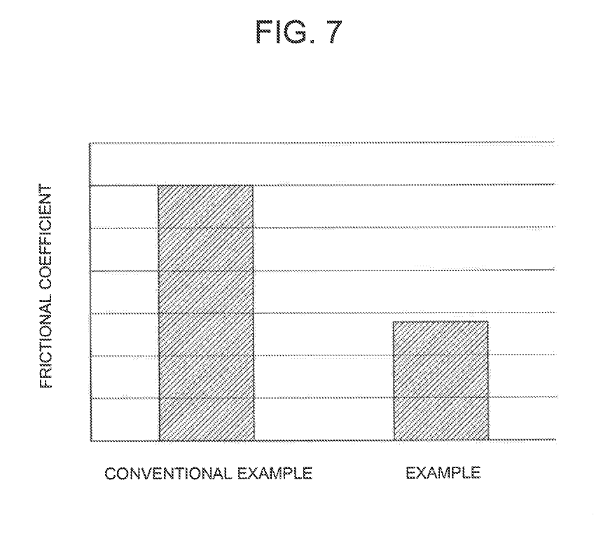

Subsequently, a result in which the frictional coefficient is verified will be described. FIG. 7 is a graph in which the example is compared with the conventional example with respect to the frictional coefficient. Furthermore, this frictional coefficient indicates a ratio of frictional force exerted on a contact surface between the separator and the cell monitor terminal, and a pressure (vertical force) vertically exerted on the contact surface.

As illustrated in FIG. 7, when the frictional coefficient of the conventional example is compared with the frictional coefficient of the Example, it is confirmed that the frictional coefficient of the example is able to be considerably reduced. Specifically, it is confirmed that the frictional coefficient of the example is able to be reduced by approximately 50% or more compared to that of the conventional example. It is preferable that the frictional coefficient of the carbon thin film layer C coated on the separator 1 in this embodiment is less than or equal to 0.15. By using such a carbon thin film layer C, it is possible to improve the insertion and extraction properties of the cell monitor terminal 30.

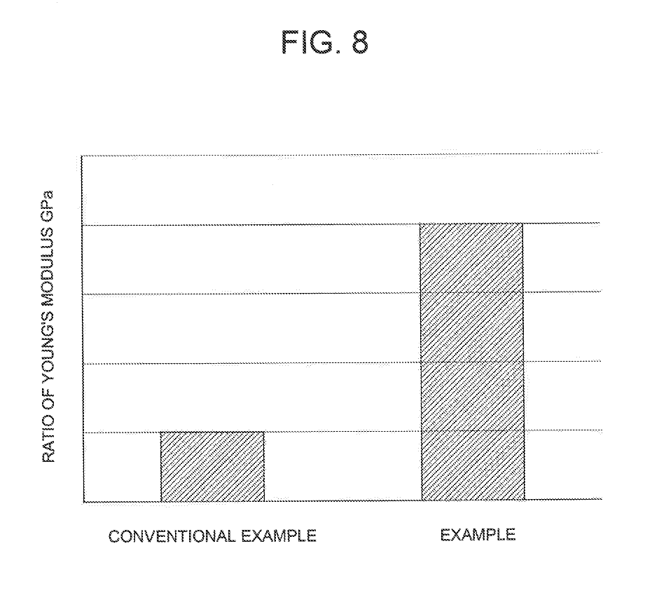

Subsequently, a result in which a Young's modulus is verified will be described. FIG. 8 is a graph in which the example is compared with the conventional example with respect to the Young's modulus.

As illustrated in FIG, 8, when the Young's modulus of the conventional example is compared with the Young's modulus of the example, it is confirmed that the Young's modulus of the example is considerably higher than the Young's modulus of the conventional example. Specifically, it is confirmed that the Young's modulus of the Example is approximately greater than or equal to 1000 times higher than the Young's modulus of the conventional example.

As described above, by setting the hardness of the conductive carbon thin film layer C formed in the terminal attachment portion A21 to which the cell monitor terminal 30 is connected to be greater than or equal to 5 GPa and less than or equal to 10 GPa, it is possible to reduce the sliding resistance and the frictional coefficient, and it is possible to increase the Young's modulus.

By setting the hardness of the carbon thin film layer C to be greater than or equal to 5 GPa, the hardness of the carbon thin film layer C is sufficiently ensured. As a result thereof, it is possible to withstand impact such as contact or friction from the outside, and for example, it is possible to suppress the peeling off of the carbon thin film layer C even at the time of the insertion and extraction of the cell monitor terminal 30 (at the time of detaching the cell monitor terminal 30). In addition, when the hardness of the carbon thin film layer C excessively increases, a cracking easily occurs in the carbon thin film layer C at the time of the insertion and extraction of the cell monitor terminal 30, but in this embodiment, the upper limit value of the hardness of the carbon thin film layer C is set to be less than or equal to 10 GPa, and thus it is possible to suppress the cracking of the carbon thin film layer C even at the time of the insertion and extraction of the cell monitor terminal 30. By setting the hardness of the carbon thin film layer C in this way, it is possible to improve the sliding durability and the insertability of the separator 1 and the cell monitor terminal 30. In addition, the carbon thin film layer C is formed in the terminal attachment portion A21, and thus metal contact does not occur in a connection portion (the contact point P) between the separator 1 and the cell monitor terminal 30, a galvanic cell due to dew condensation water is not formed, and thus it is possible to reduce contact resistance.

As described above, the embodiment of the present invention is described with reference to specific examples. However, the present invention is not limited to these specific examples. That is, examples in which the design of the specific examples is suitably changed by a person skilled in the art are included in the range of the present invention insofar as the characteristics of the present invention are included. The respective elements included in each of the specific examples described above, and the arrangement, the materials, the conditions, and the shape thereof are not limited to those exemplified, and are able to be suitably changed.

### EXPLANATION OF REFERENCES

1: SEPARATOR

10: SINGLE CELL

11: OXIDIZING GAS SUPPLY MANIFOLD

12: OXIDIZING GAS DISCHARGE MANIFOLD

13: FUEL GAS SUPPLY MANIFOLD

14: FUEL GAS DISCHARGE MANIFOLD

15: COOLING MEDIUM SUPPLY MANIFOLD

16: COOLING MEDIUM DISCHARGE MANIFOLD

30: CELL MONITOR TERMINAL

100: FUEL CELL STACK

A1: POWER GENERATION REGION

A2: NON-POWER GENERATION REGION

A21: TERMINAL ATTACHMENT PORTION (TERMINAL CONTACT MOUNTING SURFACE)

C: CARBON THIN FILM LAYER

What is claimed is:

1. A separator for a fuel cell used in a single cell which is a power generation element of a fuel cell, the separator comprising:
a terminal contact mounting surface which is disposed in a region other than a power generation region engaged in power generation of a separator main body, and to which a cell monitor terminal capable of detecting a voltage of the single cell is connected; and
a conductive carbon thin film layer which is formed on the terminal contact mounting surface,
wherein hardness of the carbon thin film layer is greater than or equal to 5 GPa and less than or equal to 10 GPa,

2. The separator for a fuel cell according to claim 1,
wherein a frictional coefficient of the carbon thin film layer is less than or equal to 0.15.
